(19) United States
(12) Patent Application Publication
(10) Pub. No.: US 2018/0085688 A1
(43) Pub. Date: Mar. 29, 2018

(54) CONTROL VALVE APPARATUS

(71) Applicant: Nidec Tosok Corporation, Zama-shi (JP)

(72) Inventors: Hiroki ISHII, Zama-shi (JP); Weiming CHEN, Zama-shi (JP)

(21) Appl. No.: 15/715,240

(22) Filed: Sep. 26, 2017

(30) Foreign Application Priority Data
Sep. 28, 2016 (JP) 2016-190073

(51) Int. Cl. B01D 29/00; F16K 11/07; F16K 31/06

(52) U.S. Cl. CPC B01D 29/0097; B01D 2201/16; F16K 31/0613; F16K 11/0716

(57) ABSTRACT

A strip-shaped filter in the shape of a circular arc is arranged at a port opening portion of an oil passage, the port opening portion being in maximum proximity to a spool hole portion or a valve element, to prevent a contaminant in the oil passage from reaching the spool hole portion or the valve element. A groove portion is arranged to extend in a circumferential direction in a wall surface of the upper body which defines the spool hole portion. The port opening portion is defined in the groove portion, and is connected to the oil passage. The filter is housed in the groove portion to close the port opening portion defined in the groove portion.

### CROSS REFERENCE TO RELATED APPLICATIONS

This application claims the benefit of priority to Japanese Patent Application No. 2016-190073 filed on Sep. 28, 2016. The entire contents of this application are hereby incorporated herein by reference.

### BACKGROUND OF THE INVENTION

### 1. Field of the Invention

The present invention relates to a control valve apparatus used in, for example, an automatic transmission of a vehicle.

### 2. Description of the Related Art

Automatic transmissions of vehicles include a control valve for controlling a transmission mechanism. The control valve controls the transmission mechanism by supplying or stopping supplying a predetermined oil pressure to the transmission mechanism by using a control valve apparatus.

Such a control valve apparatus is described in, for example, JP-A 2014-234831.

In the control valve apparatus described in JP-A 2014-234831, a columnar spool hole portion is defined in a valve body including an oil passage defined therein, and a columnar valve element is installed in the spool hole portion such that the valve element is movable in the spool hole portion. The valve element is arranged to move by being pressed by a solenoid outside of the valve body to open or close a port opening of the oil passage which opens into the spool hole portion.

A control valve apparatus of this type is typically provided with a filter to prevent an extraneous material in a valve body from reaching a valve element. Extraneous materials are generally called contaminants, and are generated when an oil passage, a port opening portion, and the like are defined in the valve body by cutting processes. In addition, extraneous materials may be introduced into an oil passage from another device connected to the control valve apparatus, such as, for example, an automatic transmission or an oil feed pipe, and reach a spool hole portion or the valve element.

As is typically the case with the control valve apparatus described in JP-A 2014-234831, a filter of this type is generally arranged at an opening portion of an oil passage defined in an outer wall surface of a valve body because, in this case, an attachment of the filter can be easily performed from outside of the valve body. However, the oil passage has an extension of a certain length between the outer wall surface of the valve body and the spool hole portion, in which the valve element is installed, and therefore, contaminants in the oil passage, particularly, contaminants such as, for example, chips generated when the oil passage is defined in the valve body, could not be prevented from reaching the spool hole portion or the valve element by the filter arranged at the outer wall surface of the valve body.

This is also the case when a valve body includes an upper body and a lower body and a filter is held between the upper and lower bodies. In this case, a contaminant in an oil passage extending between the filter and a spool hole portion defined in the upper body could not be prevented from reaching a valve element or the spool hole portion.

An object of the present invention is to provide a control valve apparatus which is able to prevent a contaminant in an oil passage from reaching a spool hole portion or a valve element, with a filter being arranged at a port opening portion of an oil passage, the port opening portion being in maximum proximity to the spool hole portion or the valve element.

### SUMMARY OF THE INVENTION

A control valve apparatus according to a preferred embodiment of the present invention includes a control valve body including a lower body and an upper body placed above the lower body, the upper body having defined therein an oil passage and a columnar spool hole portion connected to the oil passage; a columnar valve element arranged to be capable of moving in an axial direction of the spool hole portion in the spool hole portion; and a solenoid attached to the control valve body, and arranged to be in contact with the valve element to move the valve element. The upper body includes a wall surface arranged to define the spool hole portion, and a groove portion defined in the wall surface and arranged to extend in a circumferential direction. The groove portion has a port opening portion connected to the oil passage defined therein. The groove portion has housed therein a strip-shaped filter in a shape of a circular arc and arranged to close the port opening portion defined in the groove portion.

The control valve apparatus according to a preferred embodiment of the present invention may have any of the following features (1), (2), (3), (4), and (5).

(1) The filter is made of an elastic material, and is housed in the groove portion while being elastically deformed toward an inner side of the circular arc of the filter with the circular arc having a central angle of more than 180 degrees, and a surface of the filter which corresponds to an outer side of the circular arc is arranged to be in contact with a bottom wall portion of the groove portion due to a return force based on the elastic deformation.

(2) A recess is defined in a wall portion or a bottom wall portion of the groove portion, and the filter includes a projecting portion arranged to project toward the wall portion or the bottom wall portion of the groove portion, and to be fitted into the recess.

(3) The groove portion includes a bottom wall portion including a projecting portion arranged to project radially inward in the spool hole portion, and the projecting portion is arranged to be engaged with the filter.

(4) The groove portion is arranged to have a depth greater than a thickness of the filter, and an inner circumferential surface of the filter is arranged radially outward of the wall surface defining the spool hole portion.

(5) An open space between both end portions of the filter with respect to the circular arc of the filter is arranged on a side closer to an upper surface of the upper body at the wall surface defining the spool hole portion.

The above and other elements, features, steps, characteristics and advantages of the present invention will become more apparent from the following detailed description of the preferred embodiments with reference to the attached drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a horizontal sectional view of a control valve apparatus according to a first preferred embodiment of the present invention.

FIG. 2 is a vertical sectional view of a portion of the control valve apparatus according to the first preferred embodiment, illustrating a filter and its vicinity.

FIG. 3 is a horizontal sectional view of a portion of the control valve apparatus according to the first preferred embodiment, illustrating the filter and its vicinity.

FIG. 4 is a vertical sectional view of a portion of a control valve apparatus according to a second preferred embodiment of the present invention, illustrating a filter and its vicinity.

FIG. 5 is an enlarged vertical sectional view of a portion of a control valve apparatus according to a third preferred embodiment of the present invention, illustrating a stopping mechanism.

FIG. 6 is an enlarged vertical sectional view of a portion of a control valve apparatus according to a fourth preferred embodiment of the present invention, illustrating a stopping mechanism.

### DETAILED DESCRIPTION OF THE PREFERRED EMBODIMENTS

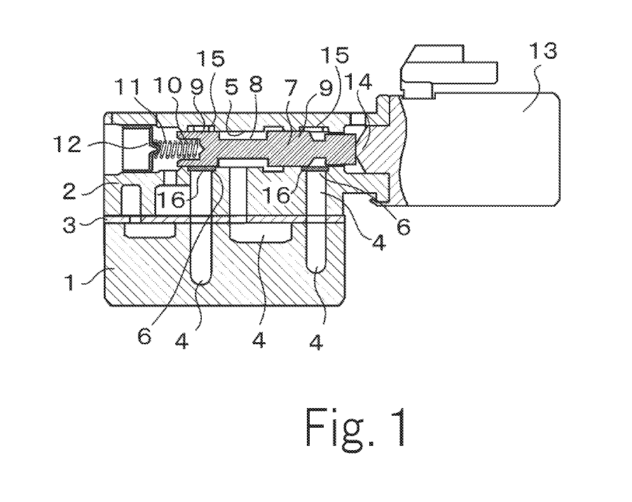

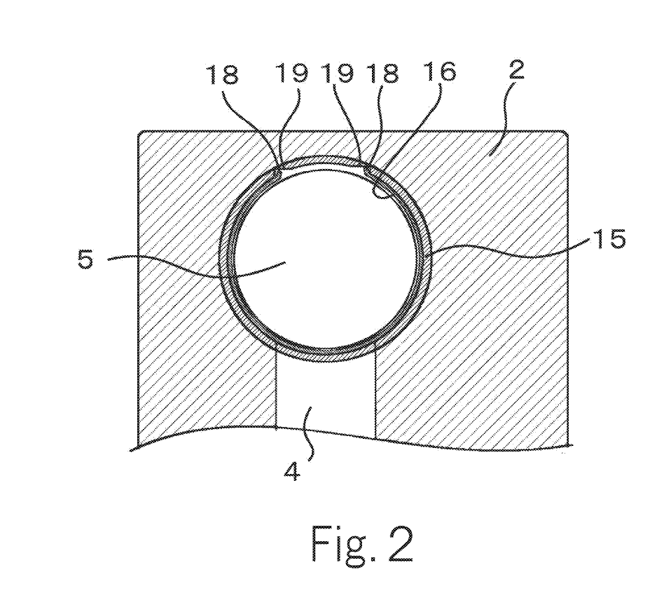

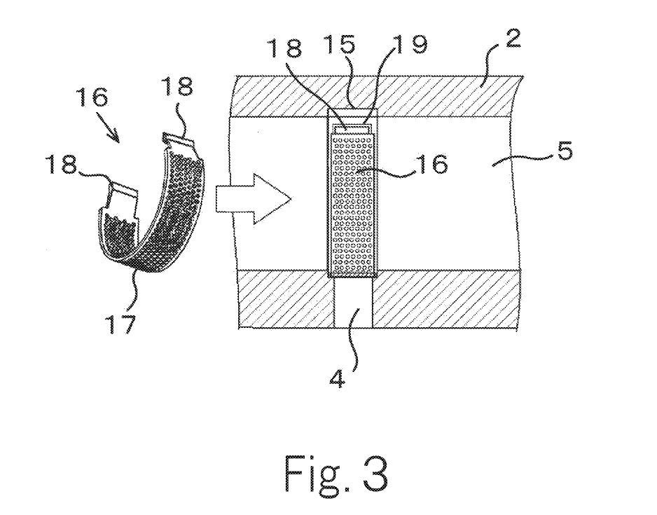

Hereinafter, preferred embodiments of the present invention will be described. It is assumed in the description of the preferred embodiments that an “axis” refers to a central axis extending along a longitudinal direction of a spool hole portion, and that a “circumferential direction” and an “axial direction” refer to a circumferential direction about the central axis and an axial direction of the central axis, respectively, unless otherwise noted. It is also assumed that a first axial end side and a second axial end side refer to a left side and a right side, respectively, in FIG. 1. It is also assumed that an upper side and a lower side are defined with respect to a direction in which an upper body and a lower body are placed one upon the other, and this definition of the upper and lower sides should not be construed to restrict the orientation of an apparatus according to any preferred embodiment of the present invention when in use.

### 1. First Preferred Embodiment

### 1-1. Structure

A control valve apparatus according to a first preferred embodiment of the present invention includes a control valve body including a lower body 1 and an upper body 2 placed above the lower body 1. The lower body 1 and the upper body 2 are fixed to each other by, for example, bolting (not shown) with a separate plate 3, which is a thin metal sheet, arranged therebetween.

A plurality of oil passages 4, which are arranged to be in communication with one another, are defined in the lower body 1 and the upper body 2. A columnar spool hole portion 5, which is arranged to be in communication with the oil passages 4, is defined in the upper body 2.

The spool hole portion 5 is bored in the upper body 2 such that the spool hole portion 5 extends in a left-right direction in FIG. 1 with a first axial end of the spool hole portion 5 opening in a left side surface of the upper body 2. Among the oil passages 4 defined in the upper body 2, the oil passages 4 which are connected to the spool hole portion 5 are each arranged to extend upward from a lower surface of the upper body 2 to a wall surface of the upper body 2 defining the spool hole portion 5 through a portion of the upper body 2. Port opening portions 6 according to the present preferred embodiment are opening portions defined in the wall surface defining the spool hole portion 5.

In the spool hole portion 5, a columnar valve element 7 is arranged to be capable of moving in an axial direction of the spool hole portion 5. An outer circumferential surface of the valve element 7 includes a recessed portion 8 arranged to connect the port opening portions 6, and projecting portions 9 each of which is arranged to close the corresponding port opening portion 6. A movement of the valve element 7 in the left-right direction in FIG. 1 causes each projecting portion 9 to open or close the corresponding port opening portion 6. The valve element 7 includes a recessed portion 10 defined therein at a first axial end thereof, and a coil spring 11 is fitted into the recessed portion 10. A first axial end of the coil spring 11 is arranged to protrude from the recessed portion 10. The first axial end of the spool hole portion 5 opens in a side surface of the control valve body on the first axial end side, and this opening portion is closed by a cap 12. The first axial end of the coil spring 11 is arranged to be in contact with the cap 12, and the coil spring 11 is installed in a compressed state between the cap 12 and the recessed portion 10. As a result, the valve element 7 is pressed by the coil spring 11 to the second axial end side.

A solenoid 13, which is arranged to move the valve element 7, is arranged on the second axial end side of the spool hole portion 5. The solenoid 13 is fixed to a side wall of the control valve body on the second axial end side. A push rod 14 of the solenoid 13 is inserted into the spool hole portion 5 through a through hole defined on the second axial end side of the spool hole portion 5. A first axial end of the push rod 14 is arranged to be in contact with a second axial end of the valve element 7 to press the valve element 7 against a pressing force by the coil spring 11

The wall surface of the upper body 2 which defines the spool hole portion 5 includes groove portions 15 each of which extends in a circumferential direction. Each groove portion 15 has defined therein the port opening portion 6 connected to the corresponding oil passage 4. A strip-shaped filter 16, which is in the shape of a circular arc and is arranged to close the port opening portion 6, is housed in the groove portion 15. The filter 16 is defined by a strip-shaped member made of an elastic material and capable of being accommodated in the groove portion 15, and is preferably in the shape of a circular arc having a curvature gentler than a curvature of the wall surface defining the spool hole portion 5 before the filter 16 is housed in the groove portion 15. Note, however, that the filter 16 may not necessarily be in the shape of a circular arc, but may alternatively be in the shape of a straight plane. In the case where the filter 16 is in the shape of a circular arc before being housed in the groove portion 15, the filter 16 can be more closely adhered to the groove portion 15, making it less likely for the filter 16 to lift up, in a state in which the filter 16 is housed in the groove portion 15.

The filter 16 is housed in the groove portion 15 while being elastically deformed toward an inner side of the circular arc of the filter 16. Notice that a surface of the filter 16 which corresponds to an outer side of the circular arc is brought into contact with a bottom wall portion of the groove portion 15 by a return force based on the elastic deformation such that a central angle of the circular arc of the filter 16 exceeds 180 degrees in the state in which the filter 16 is housed in the groove portion 15. Small holes 17, which are arranged to block passage of contaminants while allowing passage of an oil, are defined in the substantially entire filter 16, excluding both end portions of the filter 16.

An open space between both end portions of the filter 16 with respect to the circular arc of the filter 16 is arranged on a side closer to an upper surface of the upper body 2 at the wall surface defining the spool hole portion 5. Projecting portions 18, each of which is arranged to project toward the bottom wall portion of the groove portion 15, are arranged at both ends of the filter 16. The bottom wall portion of the groove portion 15 includes a recess 19, and the projecting portions 18 of the filter 16 are fitted into the recess 19. The groove portion 15 is arranged to have a depth greater than a thickness of the filter 16, and an inner circumferential surface of the filter 16 is arranged radially outward of the wall surface defining the spool hole portion 5.

### 1-2. Operation

When the filters 16 are attached to the corresponding groove portions 15 in the control valve apparatus according to the present preferred embodiment, each filter 16 is inserted into the spool hole portion 5 through the opening portion at the first axial end of the spool hole portion 5 before the valve element 7 is inserted into the spool hole portion 5. When the filter 16 is inserted into the spool hole portion 5, the filter 16, which is made of the elastic material and is in the shape of a circular arc, is rolled so as to decrease the diameter of the circular arc thereof, and is held with a jig to make the diameter of the circular arc thereof smaller than a diameter of the spool hole portion 5.

At this time, the filter 16 is inserted into the spool hole portion 5 with the open space between both the ends of the filter 16 facing upward in FIG. 1 so that positions of the projecting portions 18 of the filter 16 can agree with a position of the recess 19 defined in the corresponding groove portion 15.

After the filter 16 reaches the corresponding groove portion 15, the holding of the filter 16 by the jig is released, so that the filter 16 spreads radially outward due to elasticity thereof and is housed in the groove portion 15. In the state in which the filter 16 is housed in the groove portion 15, the filter 16 is in the shape of a circular arc having a central angle of more than 180 degrees, and therefore, the surface of the filter 16 which corresponds to the outer side of the circular arc is pressed against the bottom wall portion of the groove portion 15 by the return force based on the elastic deformation to prevent a detachment of the filter 16 out of the groove portion 15. At the same time, the projecting portions 18 arranged at both the ends of the filter 16 are engaged with the recess 19 of the bottom wall portion of the groove portion 15 to serve as stops to prevent the filter 16 from moving in the circumferential direction in the groove portion 15.

After the attachment of the filters 16 is completed, the valve element 7 and the coil spring 11 are inserted into the spool hole portion 5, and the opening portion at the first axial end of the spool hole portion 5 is closed by the cap 12 to complete installation of the valve element 7.

In the control valve apparatus according to the present preferred embodiment having the above-described structure, contaminants in the oil passages 4 of the control valve body would be blocked by the filters 16 arranged at the port opening portions 6, and could not enter into the spool hole portion 5. When each filter 16 housed in the corresponding groove portion 15 is to be removed, a jig is inserted into the corresponding oil passage 4, which opens in a bottom surface of the upper body 2, to cause the filter 16 to lift up from the groove portion 15, and in this state, a shaft is inserted into the spool hole portion 5 through the opening portion at the first axial end of the spool hole portion 5, and the filter 16 is grasped by the shaft and is removed out of the control valve body.

### 1-3. Beneficial Effects

The present preferred embodiment is able to achieve the following beneficial effects.

(1) Since the groove portions 15, each of which is arranged to extend in the circumferential direction in the wall surface of the upper body 2 defining the spool hole portion 5, the port opening portions 6, each of which is arranged to open in the corresponding groove portion 15 and is connected to the corresponding oil passage 4, and the strip-shaped filters 16, each of which is in the shape of a circular arc and is housed in the corresponding groove portion 15 to close the port opening portion 6 in the corresponding groove portion 15, are provided, each filter 16 can be arranged in proximity to the valve element 7, making it possible to capture contaminants remaining in the oil passages 4 in the control valve body in a manufacturing process before the contaminants reach the valve element 7. Even if a contaminant should be left in any oil passage 4 after the manufacture and assembly, the contaminant could be securely captured before reaching the valve element 7.

(2) A combination of the groove portion 15 and the strip-shaped filter 16 allows the filter 16 to be so securely positioned as to prevent the filter 16 from being displaced from the port opening portion 6 of the oil passage 4 defined in the bottom wall portion of the groove portion 15.

(3) Since each filter 16 is made of the elastic material, is arranged to be in the shape of a circular arc having a central angle of more than 180 degrees in the state in which the filter 16 is housed in the corresponding groove portion 15, and is housed in the corresponding groove portion 15 while being elastically deformed toward the inner side of the circular arc of the filter 16, the filter 16 is closely adhered to a bottom surface of the corresponding groove portion 15 due to the elasticity thereof, and securely closes the corresponding port opening portion 6 without a gap being defined between the filter 16 and the corresponding port opening portion 6.

(4) Since the bottom wall portion of each groove portion 15 includes the recess 19, each filter 16 includes the projecting portions 18 each of which is arranged to project toward the bottom wall portion of the corresponding groove portion 15, and the projecting portions 18 are fitted into the recess 19, the positioning of each filter 16 can be securely achieved. In addition, when the spool hole portion 5 and the groove portions 15 are defined in the control valve body, the recess 19 can be defined in each groove portion 15 at the same time, allowing the control valve body to be manufactured in a simple manner.

(5) Since each groove portion 15 is arranged to have a depth greater than the thickness of the corresponding filter 16, and the inner circumferential surface of each filter 16 is arranged radially outward of the wall surface defining the spool hole portion 5, the filter 16 does not protrude from an edge of the corresponding groove portion 15, and the filter 16 does not interfere with the movement of the valve element 7.

(6) The open space between both the end portions of the filter 16 with respect to the circular arc of the filter 16 is arranged on the side closer to the upper surface of the upper body 2 at the wall surface defining the spool hole portion 5. Therefore, in the case where both the end portions of the filter 16 are restrained by the recess 19 and the projecting portions 18 from moving, if the recess 19 and the projecting portions 18, which serve as stops, are arranged on the side closer to the upper surface of the upper body 2, a machine tool can be inserted into the corresponding oil passage 4, which passes through a portion of the upper body 2 on the side closer to the lower surface of the upper body 2, toward the spool hole portion 5, and the recess 19 can be easily defined on the upper side of the spool hole portion 5 using a tip of the machine tool.

### 2. Other Preferred Embodiments

The present invention is not limited to the above-described preferred embodiment. The above-described preferred embodiment has been presented by way of example only, and the present invention can be embodied in a variety of other forms. In other preferred embodiments of the present invention, various omissions, substitutions, and changes may be made without departing from the scope of the invention. These preferred embodiments and modifications thereof fall within the scope and spirit of the invention and the scope of equivalents thereof. Examples thereof will now be described below.

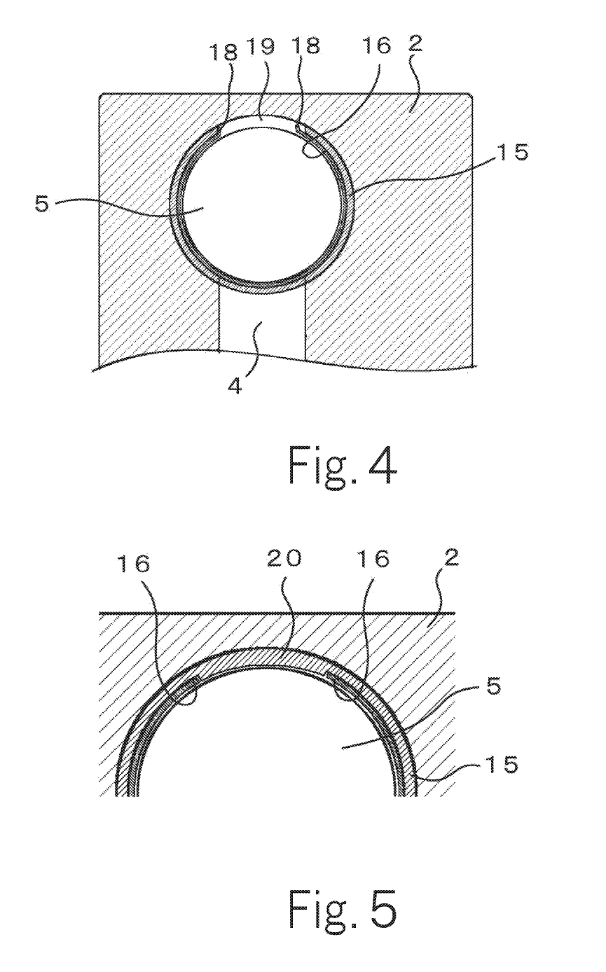

(1) As illustrated in FIG. 4, only one of the projecting portions 18 at both the ends of the filter 16 may be engaged with one of wall portions defining portions of the recess 19 defined in the bottom wall portion of the groove portion 15. This is because, in the case where an area in which the small holes 17 are defined in the strip-shaped filter 16 is large enough to cover the port opening portion 6, the port opening portion 6 can be covered with the filter 16 if one of the projecting portions 18 at both the ends of the filter 16 is engaged with the wall portion on either side of the recess 19.

(2) As illustrated in FIG. 5, a projecting portion 20, which is arranged to project radially inward in the spool hole portion 5 and which is arranged to be engaged with the filter 16, may alternatively be defined in the bottom wall portion of the groove portion 15. In this case, the projecting portion 20 may be arranged to extend in the circumferential direction as illustrated in FIG. 5, or may alternatively be in the shape of a pin. In addition, a portion of the filter 16 with which the projecting portion 20 is to be engaged may be an edge of the filter 16, and may be subjected to a punching process, and at the same time may be provided with a hole with which the projecting portion 20 is to be engaged. In this case, the structure of a stopping portion defined in the filter 16 can be simple.

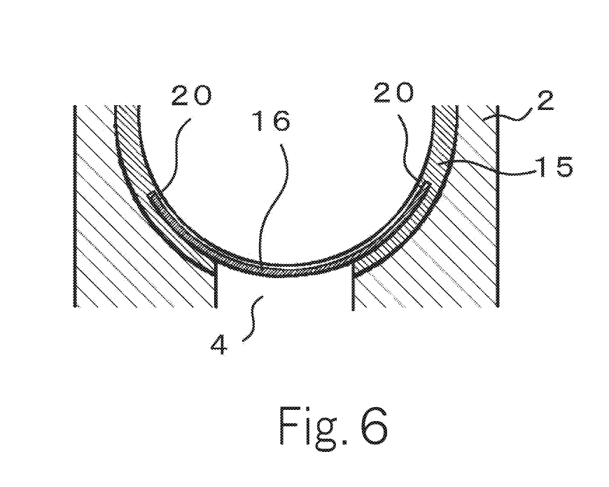

(3) As illustrated in FIG. 6, the filter 16 may alternatively be in the shape of a circular arc having a central angle of 180 degrees or less. In this case, a pair of projecting portions 20, which are arranged to hold both the ends of the filter 16, are arranged at the groove portion 15 to prevent the filter 16 from lifting up from the groove portion 15. In this case, the filter 16 can be defined by a small member having a length smaller than the diameter of the spool hole portion 5, and therefore, the filter 16 can be easily inserted into the corresponding groove portion 15 through the first axial end of the spool hole portion 5.

(4) Each of the projecting portions 20 and the recess 19, which serve as stops for the filter 16, may not necessarily be defined in the bottom wall portion of the groove portion 15, but may alternatively be defined in an inner wall surface of the upper body 2 defining a portion of the groove portion 15. In this case, the projecting portions 18 of the filter 16, with which the projecting portion(s) 20 or the recess 19 is to be engaged, are defined in a side edge of the filter 16.

(5) In the case where the filter 16 is arranged to be in the shape of a circular arc having a central angle of 180 degrees or more, and is arranged to be strongly pressed against the bottom wall portion of the corresponding groove portion 15 due to an elastic force of the filter 16, a stop may not necessarily be provided. This is because friction between the filter 16 and the bottom wall portion of the groove portion 15 prevents a movement of the filter 16 relative to the bottom wall portion of the groove portion 15. In this case, none of the projecting portions 18 and the recess 19 need to be defined in the filter 16 or the groove portion 15, and the structure of the control valve apparatus is simplified.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A control valve apparatus comprising:
a control valve body including a lower body and an upper body placed above the lower body, the upper body having defined therein an oil passage and a columnar spool hole portion connected to the oil passage;
a columnar valve element arranged to be capable of moving in an axial direction of the spool hole portion in the spool hole portion; and
a solenoid attached to the control valve body, and arranged to be in contact with the valve element to move the valve element; wherein the upper body includes a wall surface arranged to define the spool hole portion, and a groove portion defined in the wall surface and arranged to extend in a circumferential direction;
the groove portion has a port opening portion connected to the oil passage defined therein; and
the groove portion has housed therein a strip-shaped filter in a shape of a circular arc and arranged to close the port opening portion defined in the groove portion.

2. The control valve apparatus according to claim 1, wherein
the filter is made of an elastic material, and is housed in the groove portion while being elastically deformed toward an inner side of the circular arc of the filter with the circular arc having a central angle of more than 180 degrees; and
a surface of the filter which corresponds to an outer side of the circular arc is arranged to be in contact with a bottom wall portion of the groove portion due to a return force based on the elastic deformation.

3. The control valve apparatus according to claim 1, wherein
a recess is defined in a wall portion or a bottom wall portion of the groove portion; and
the filter includes a projecting portion arranged to project toward the wall portion or the bottom wall portion of the groove portion, and to be fitted into the recess.

4. The control valve apparatus according to claim 1, wherein
the groove portion includes a bottom wall portion including a projecting portion arranged to project radially inward in the spool hole portion; and
the projecting portion is arranged to be engaged with the filter.

5. The control valve apparatus according to claim 1, wherein the groove portion is arranged to have a depth greater than a thickness of the filter, and an inner circumferential surface of the filter is arranged radially outward of the wall surface defining the spool hole portion.

6. The control valve apparatus according to claim 5, wherein an open space between both end portions of the filter with respect to the circular arc of the filter is arranged on a side closer to an upper surface of the upper body at the wall surface defining the spool hole portion.
